(19) United States
(12) Patent Application Publication
(10) Pub. No.: US 2024/0368944 A1
(43) Pub. Date: Nov. 7, 2024

(54) ADJUSTABLE LADDER LEVELER

(71) Applicant: Wayne Shaffer, Farmington, NY (US)

(72) Inventor: Wayne Shaffer, Farmington, NY (US)

(21) Appl. No.: 18/648,590

(22) Filed: Apr. 29, 2024

Related U.S. Application Data
(60) Provisional application No. 63/464,552, filed on May 6, 2023.

(51) Int. Cl. E06C 7/44; E06C 1/22

(52) U.S. Cl. CPC E06C 7/44; E06C 1/22

(57) ABSTRACT

An adjustable ladder leveler includes a channel shaped base member; a slide member, slidably engaged with the channel shaped base member; a ladder foot holder member, operatively connected to the slide member, configured to engage a foot of a ladder; and a ladder leveler pivotal foot member, operatively connected to an end of the channel shaped base member, configured to engage a surface; the channel shaped base member including a set of channel shaped base member opposing through holes; the slide member including a set of slide member opposing through holes. Adjacent opposing through holes of the set of channel shaped base member opposing through holes have a first predetermined distance therebetween, and adjacent opposing through holes of the set of slide member opposing through holes have a second predetermined distance therebetween, the first predetermined distance being not equal to the second predetermined distance.

### PRIORITY INFORMATION

The present application claims priority, under 35 U.S.C. § 119 (e), from U.S. Provisional Patent Application, Ser. No. 63/464,552, filed on May 6, 2023. The entire content of U.S. Provisional Patent Application, Ser. No. 63/464,552, filed on May 6, 2023, is hereby incorporated by reference.

### BACKGROUND

When using a ladder, the individual expects security from the ladder falling when climbing on a ladder. Such security can be achieved the ladder is level from the point of origin upward. However, there are a number of instances where this would not be the case.

For example, if an individual is working outside with a ladder, the ground may not be exactly level. Another example would be if an individual were trying to paint a stairway, the steps are not deep enough to get both legs of the ladder on one level.

One conventional solution to the stairway is to use a ladder that has four or five different sections that basically form into a scaffolding type configuration.

Another conventional solution for an unlevel or uneven surface is to have someone hold the ladder in an effort to help stabilize and balance it. While this typically works well if the individual climbing on the ladder is handling a task that is straight up, it becomes a little more problematic if the individual is reaching out to the sides to perform a task.

As mentioned above, working on a set of stairs is probably one of the toughest tasks that can be performed on a ladder. Often times, there is no place to brace the ladder or the angle in which a person must brace the ladder leaves one leg hanging in the air.

Conventional ladder levelers, which are attachable to the side rails of a ladder, have been used in such situations, but are complicated and time consuming to attach and secure properly. Other conventional ladder levelers attach directly to the rung or rungs on the inside portion of the ladder creating issues for the users as the user climbs up and down the ladder.

An example of a conventional ladder leveler is disclosed in U.S. Pat. No. 5,174,412 and illustrated in FIG. 1. The entire content of U.S. Pat. No. 5,174,412 is hereby incorporated by reference.

As illustrated in FIG. 1, a ladder leveler device which attaches onto a ladder leg needing to be extended comprises the parts of: rung support cup means 2; two matched side walls 1; a channel sleeve 3, including pin holes 4; an in-track leg 5, including in-track pin holes 6; a pivot pin 11; a pivotal foot 7; and a holding pin 10. The ladder leveling accessory, as illustrated in FIG. 1, includes a sleeve that engages a ladder's rungs. The ladder leveling accessory further includes a leg extension member that extends from the sleeve to give the ladder leveling accessory a desired length.

An example of a conventional ladder leveler is disclosed in U.S. Pat. No. 6,702,066 and illustrated in FIG. 2. The entire content of U.S. Pat. No. 6,702,066 is hereby incorporated by reference.

As illustrated in FIG. 2, a telescoping ladder includes two telescoping ladder racks, the top of the two telescoping ladder racks are pivoted together in a scissor structure that can be opened and closed. The telescoping ladder rack has an inner ladder rack 10 and an outer ladder rack 20 connected together in a telescoping way.

The inner ladder rack 10 has two inner legs 12 and a plurality of inner cross beams 14 connecting the two inner legs 12. The outer ladder rack 20 has two outer legs 22 and a plurality of outer cross beams 24 connecting the two outer legs 22. Two outer legs 22 are disposed at the outer side of the two inner legs 12. The telescoping ladder, as illustrated in FIG. 2, includes a leg extension member having two connecting bolts that slide in a pre-formed slot in a ladder leg. The two connecting bolts are tightened at a desired position along the slot to give the ladder leveling accessory a desired length.

Another example of a conventional ladder leveler is disclosed in U.S. Pat. No. 4,091,893. U.S. Pat. No. 4,091,893 discloses a ladder leveling accessory that includes a sleeve that is bolted to the ladder leg. The ladder leveling accessory further includes a leg extension member that extends from the sleeve to give the ladder leveling accessory a desired length. The entire content of U.S. Pat. No. 4,091,893 is hereby incorporated by reference.

A further example of a conventional ladder leveler is disclosed in U.S. Pat. No. 5,307,900 93. U.S. Pat. No. 5,307,900 discloses a ladder leveling accessory that includes a sleeve that has positioning holes therein. The positioning holes and a pin engage pre-drilled holes in the ladder leg to give the ladder leveling accessory a desired length. The entire content of U.S. Pat. No. 5,307,900 is hereby incorporated by reference.

Another example of a conventional ladder leveler is disclosed in Published US Patent Application Number 2007/0089933. Published US Patent Application Number 2007/0089933 discloses a ladder leveling accessory that includes a leg extension member and a ladder leg holding member. The leg extension member is a threaded shaft for giving the ladder leveling accessory a desired length. The entire content of Published US Patent Application Number 2007/0089933 is hereby incorporated by reference.

Lastly, an example of a conventional ladder leveler is disclosed in Published US Patent Application Number 2021/0198946. Published US Patent Application Number 2021/0198946 discloses a ladder leveling accessory that engages the open ends of the rungs of the ladder to connect thereto. The ladder leveling accessory includes a leg extension member for giving the ladder leveling accessory a desired length. The entire content of Published US Patent Application Number 2021/0198946 is hereby incorporated by reference.

As disclosed above, many of the disclosed conventional ladder levelers require physical changes to the ladder's legs to be utilized. Moreover, as disclosed above, many of the disclosed conventional ladder levelers do not provide extended flexibility in setting the ladder leveling accessory at a desired length.

Thus, it is desirable to provide an adjustable ladder leveler that does not require physical changes to the ladder's legs to be utilized.

Moreover, it is desirable to provide an adjustable ladder leveler that provides extended flexibility in setting the ladder leveling accessory at a desired length.

Additionally, it is desirable to provide an adjustable ladder leveler that provides extended flexibility in setting the ladder leveling accessory at a desired length and does not require physical changes to the ladder's legs to be utilized.

### BRIEF DESCRIPTION OF THE DRAWINGS

The drawings are only for purposes of illustrating various embodiments and are not to be construed as limiting, wherein:

FIG. 1 illustrates a prior art ladder leveler;

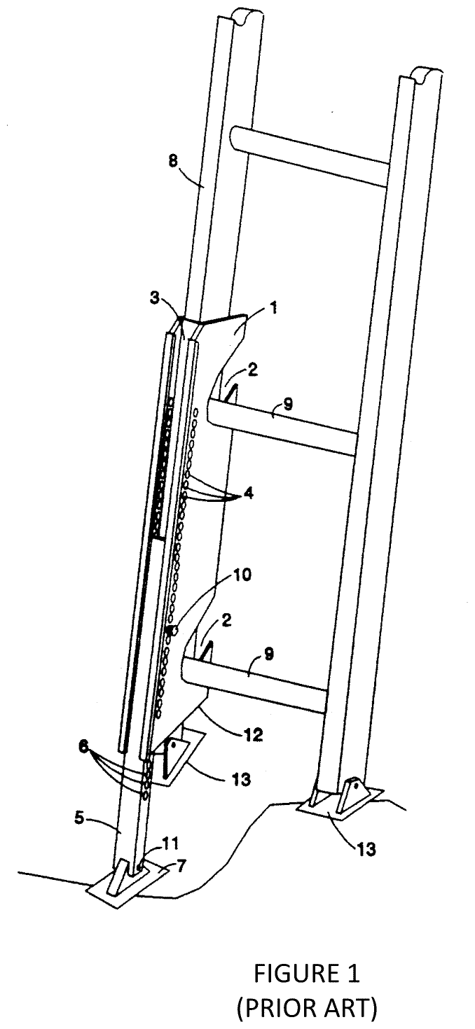

FIG. 2 illustrates another prior art ladder leveler;

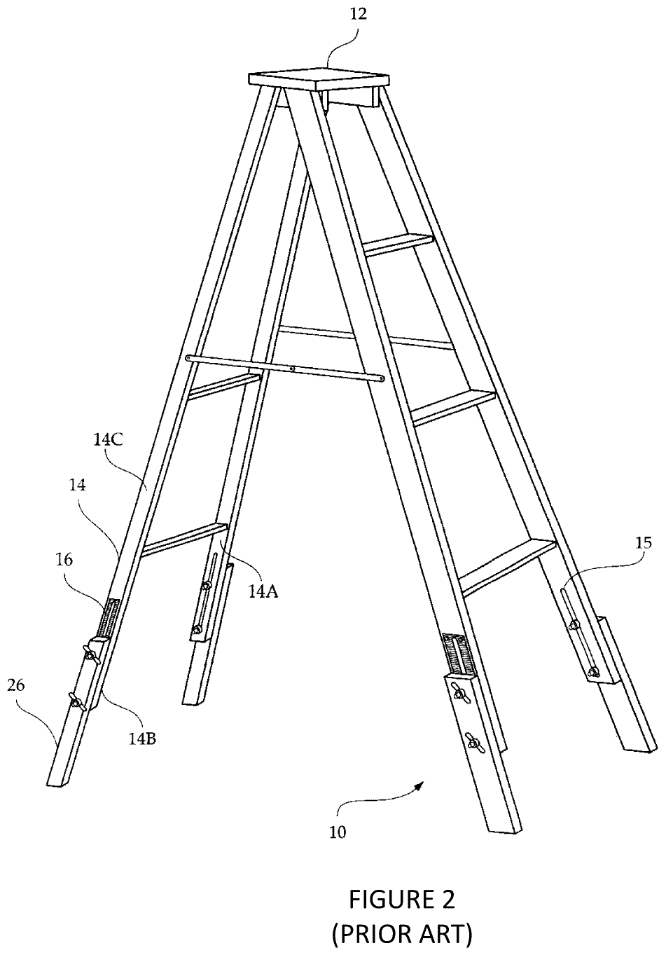

FIG. 3 illustrates an assembled adjustable ladder leveler;

FIG. 4 illustrates a foot member of a ladder foot holder member of the assembled adjustable ladder leveler of FIG. 3;

FIG. 5 illustrates an optional cover member of a ladder foot holder member of the assembled adjustable ladder leveler of FIG. 3;

FIG. 6 illustrates a slide member of the assembled adjustable ladder leveler of FIG. 3;

FIG. 7 illustrates a base member of the assembled adjustable ladder leveler of FIG. 3;

FIG. 8 illustrates a ladder leveler pivotal foot member of the assembled adjustable ladder leveler of FIG. 3;

FIG. 9 illustrates a pin member of the assembled adjustable ladder leveler of FIG. 3;

FIG. 10 illustrates another embodiment of a slide member of the assembled adjustable ladder leveler of FIG. 3;

FIG. 11 shows an assembled adjustable level ladder; and

FIG. 12 shows the adjustable level ladder without the leveler member.

### DETAILED DESCRIPTION OF THE DRAWINGS

For a general understanding, reference is made to the drawings. In in the description below, like references in the referenced Figures have been used throughout to designate identical or equivalent elements. It is also noted that the drawings may not have been drawn to scale and that certain regions may have been purposely drawn disproportionately so that the features and concepts may be properly illustrate

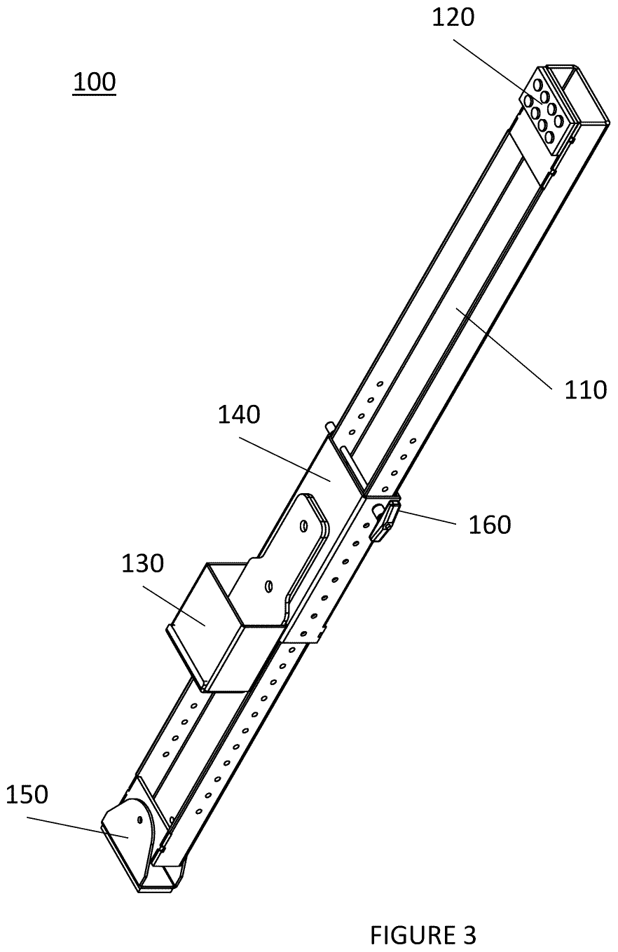

FIG. 3 illustrates an assembled adjustable ladder leveler for attaching to one leg of a ladder, wherein a ladder may be constructed of two legs with multiple rungs positioned therebetween. As illustrated in FIG. 3, an assembled adjustable ladder leveler 100 includes a base member 110. In a preferred embodiment, the base member 110 has a U-shape or channel shape. In other words, in a preferred embodiment, the base member 110 is constructed of a base back member and two base side members to form the U-shape or channel shape.

Moreover, the base member 110 has opposing through holes along a portion of the two base side members; i.e., a through hole located on one base side member has a corresponding opposing through hole on the other opposite base side member.

A non-skid member 120 is located at a first end of the base member 110 and a ladder leveler pivotal foot member 150 is pivotally attached to a second end of the base member 110. The ladder leveler pivotal foot 150 is pivotally attached to a second end of the base member 110 such that the ladder leveler pivotal foot member 150 can properly engage a surface while maintaining a desired slope of the adjustable ladder leveler 100 and attached ladder.

The assembled adjustable ladder leveler 100 also includes a ladder foot holder member 130 configured to securely hold or contain a foot of a ladder's leg. The assembled adjustable ladder leveler 100 further includes a slide member 140, which is attached to the ladder foot holder member 130 and is slidably engaged with the base member 110.

In one embodiment, the slide member 14 has a U-shape or channel shape. In other words, in this embodiment, the slide member 140 is constructed of a slide back member and two slide side members to form the U-shape or channel shape.

As illustrated, the slide member 140 has opposing through holes along a portion of the two slide side members; i.e., a through hole located on one slide side member has a corresponding opposing through hole on the other opposite slide side member.

The assembled adjustable ladder leveler 100 includes a pin member 160, which is configured to engage the through holes of the base member 110 and the through holes of the slide member 140 such that the slide member 140 is securely attached to the base member 110. The assembled adjustable ladder leveler 100 further includes a ladder side non-skid member 120 configured to engage a side of a ladder's leg.

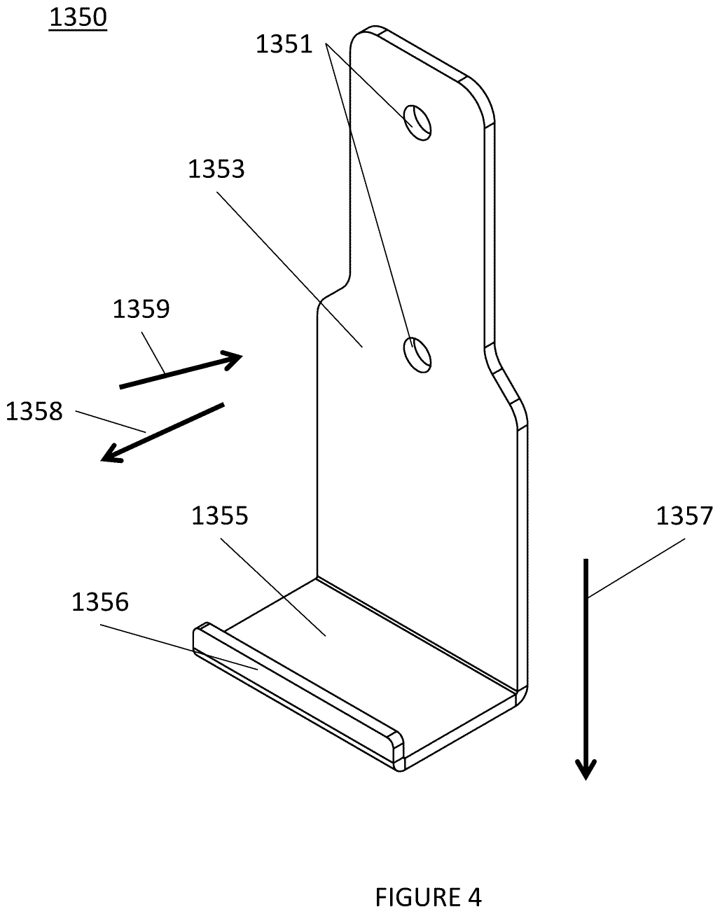

FIG. 4 illustrates a ladder foot vertical stop member of a ladder foot holder of the assembled adjustable ladder leveler of FIG. 3. As illustrated in FIG. 4, a ladder foot vertical stop member 1350 includes a vertical stop 1355, which is configured to engage a bottom of a ladder's foot so that the ladder's foot is prevented from moving in direction 1357.

The ladder foot vertical stop member 1350 also includes a first foot horizontal stop member 1353, which is configured to engage a side of a ladder's foot so that the ladder's foot is prevented from moving in direction 1359. The first foot horizontal stop member 1353 includes through holes 1351 configured to enable the ladder foot vertical stop member 1350 to be attached to the base member (not shown).

The ladder foot vertical stop member 1350 also includes a second foot horizontal stop member 1356, which is configured to engage a side of a cover member of a ladder foot holder member (not shown) to prevented the cover member of a ladder foot holder member (not shown) from moving in direction 1358.

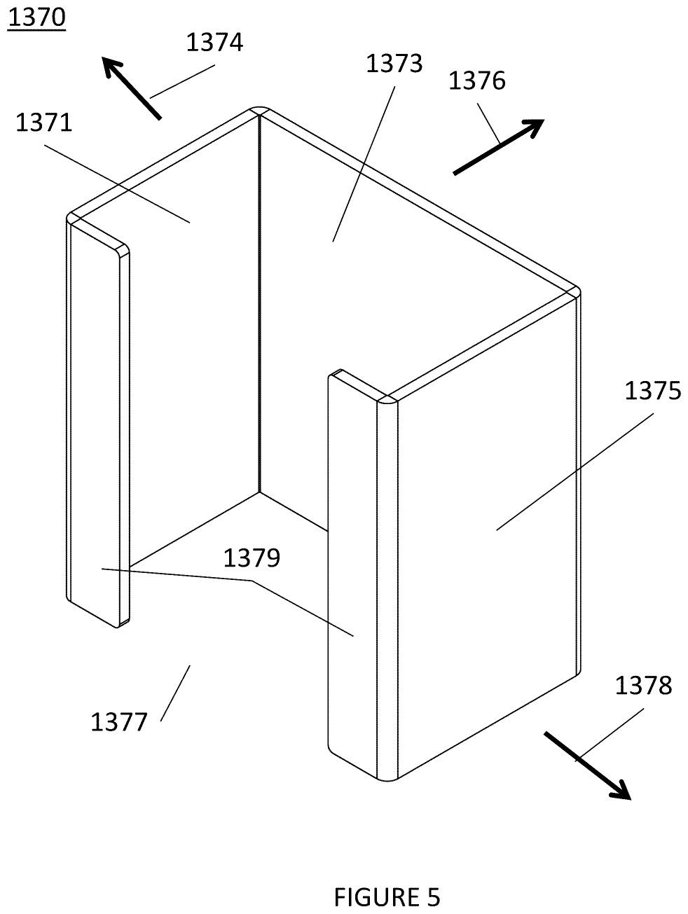

FIG. 5 illustrates an optional cover member of a ladder foot holder of the assembled adjustable ladder leveler of FIG. 3. As illustrated in FIG. 5, an optional cover member 1370 includes a first cover horizontal stop 1373, which is configured to engage a side of a ladder's foot so that the ladder's foot is prevented from moving in direction 1376.

The optional cover member 1370 also includes a second cover horizontal stop member 1371, which is configured to engage a side of a ladder's foot so that the ladder's foot is prevented from moving in direction 1374. The optional cover member 1370 includes a third cover horizontal stop member 1375, which is configured to engage a side of a ladder's foot so that the ladder's foot is prevented from moving in direction 1378.

Further, the optional cover member 1370 includes wing cover horizontal stop members 1379, which is configured to form an opening 1377 therebetween. The wing cover horizontal stop members 1379 are further configured to engage the first foot horizontal stop member of ladder foot vertical stop member (not shown) such that engagement thereof prevents the optional cover member 1370 from moving in direction 1376.

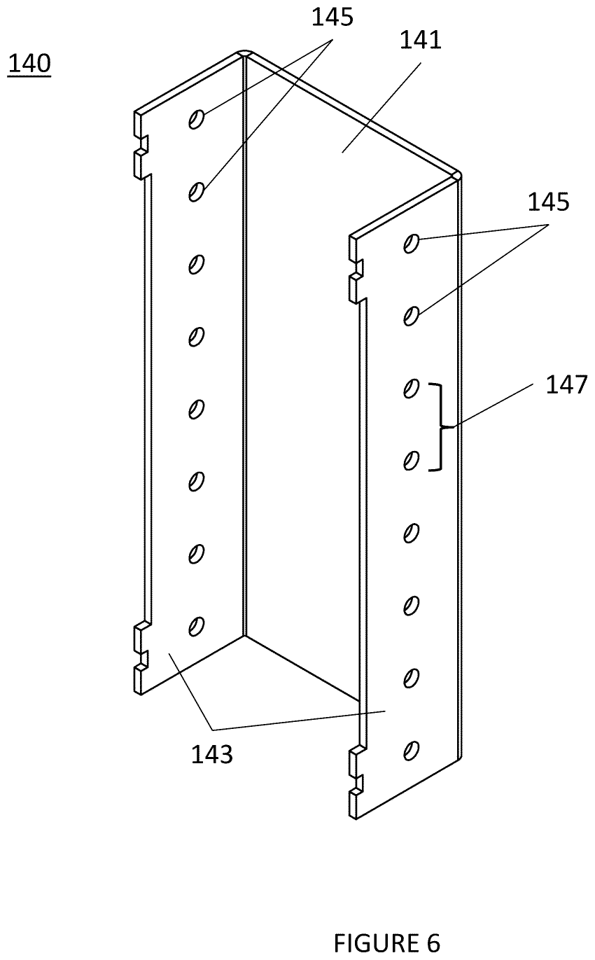

FIG. 6 illustrates one embodiment of a slide member of the assembled adjustable ladder leveler of FIG. 3. As illustrated in FIG. 6, a slide member 140 includes a slide horizontal stop member 141, which is configured to engage two base side members of the base member (not shown). The slide member 140 includes slide side members 143, which are configured to engage two base side members of the base member (not shown).

The slide side members 143 include slide opposing through holes 145. The slide opposing through holes 145 are opposing such that a through hole located on one slide side member has a corresponding opposing through hole on the other opposite slide side member. Adjacent slide opposing through holes 145 have a first predetermined distance 147 therebetween.

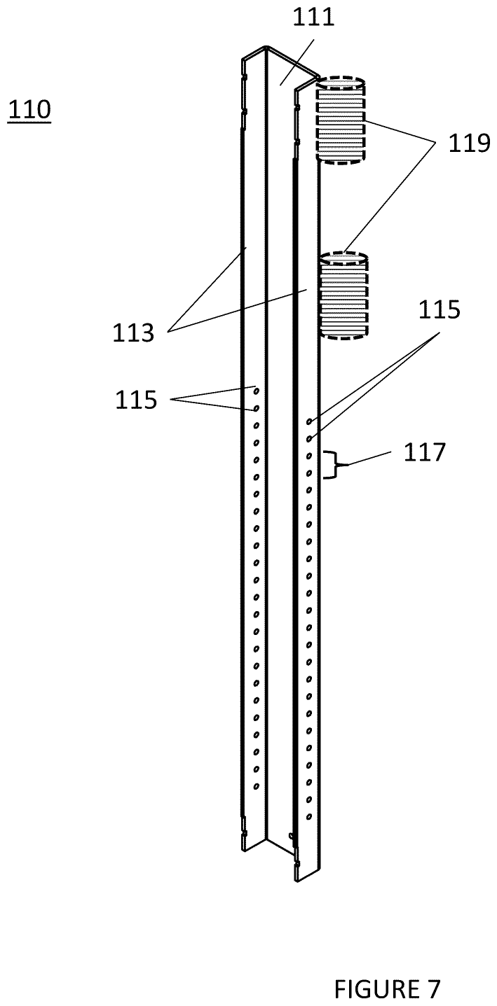

FIG. 7 illustrates a base member of the assembled adjustable ladder leveler of FIG. 3. As illustrated in FIG. 7, a base member 110 includes a base horizontal stop member 111. The base member 110 also includes base side members 113, which are configured to engage the slide horizontal stop member of the slide member (not shown).

The base side members 113 include base opposing through holes 115. The base opposing through holes 115 are opposing such that a through hole located on one base side member has a corresponding opposing through hole on the other opposite base side member. Adjacent base opposing through holes 115 have a second predetermined distance 117 therebetween.

It is noted that the first predetermined distance 147 of FIG. 6 is not equal to the second predetermined distance 117 of FIG. 7. The configuration of the non-equal distances between adjacent through holes allows greater range for adjusting the adjustable ladder leveler to a desired length.

For example, the first predetermined distance 147 of FIG. 6 may be one inch, whereas the second predetermined distance 117 of FIG. 7 may be ⅞^{th} of an inch. The first predetermined distance 147 of FIG. 6 may be greater than the second predetermined distance 117 of FIG. 7. The first predetermined distance 147 of FIG. 6 may be less than the second predetermined distance 117 of FIG. 7.

As further illustrated in FIG. 7, the base member 110 may include ratcheted strap assemblies 119 to secure a side of a ladder leg against the side of the base member 110. The optional ratcheted strap assemblies 119 provide a means for securely attaching a ladder to the adjustable ladder leveler.

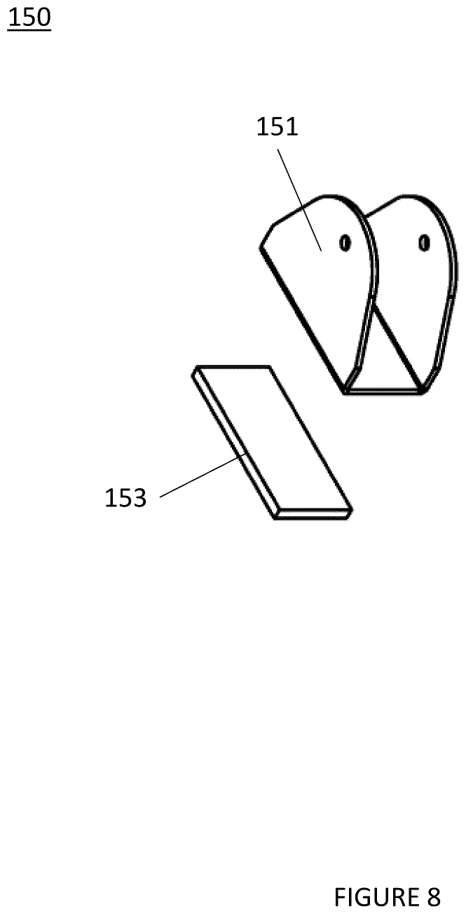

FIG. 8 illustrates a foot member of the assembled adjustable ladder leveler of FIG. 3. As illustrated in FIG. 8, a foot member 150 includes a U-shaped foot 151, with a flat bottom, configured to engage a surface. The foot member 150 may also include a non-skid member 153, which is attached to an outside surface of the bottom of the U-shaped foot 151. The U-shaped foot 151 is configured to pivotally attach to the base member (not shown).

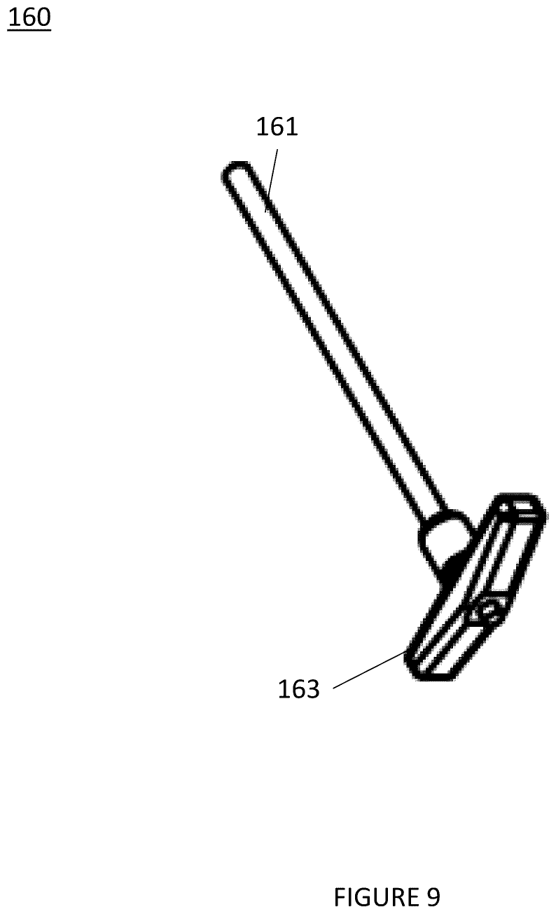

FIG. 9 illustrates a pin member of the assembled adjustable ladder leveler of FIG. 3. As illustrated in FIG. 9, a pin member 160 includes a shaft 161, configured to pass through the through holes of the slide member (not shown) and the through holes of the base member (not shown). The pin member 160 may also include a handle 163 to enable easy engagement and disengagement from the through holes of the slide member (not shown) and the through holes of the base member (not shown).

The shaft 161 may be configured to receive a lynch pin to hold the pin member 160 in place while the pin member 160 is engaged with the through holes of the slide member (not shown) and the through holes of the base member (not shown).

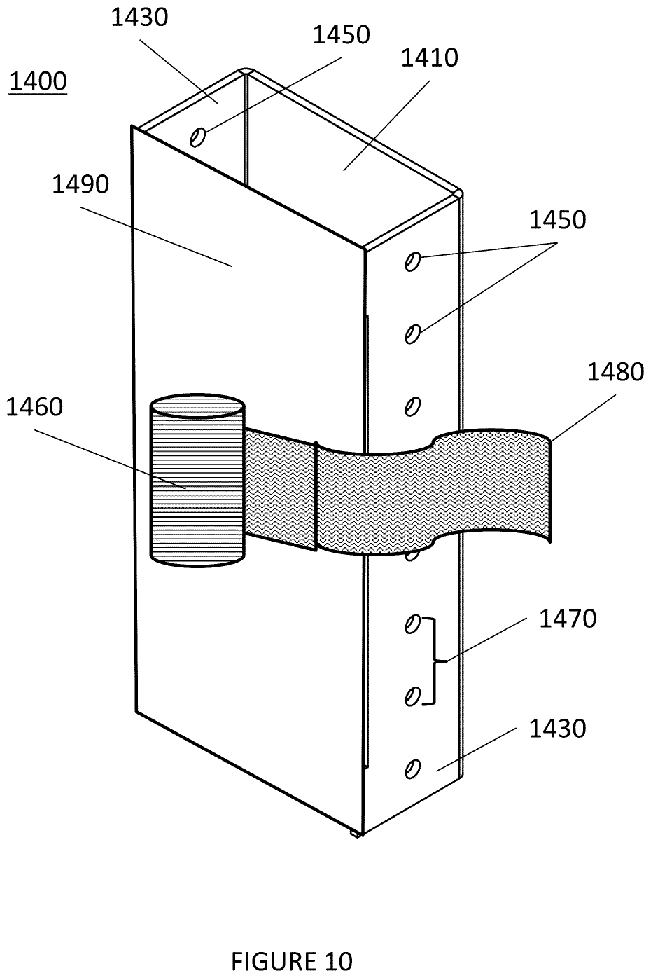

FIG. 10 illustrates another embodiment of a slide member of the assembled adjustable ladder leveler of FIG. 3. As illustrated in FIG. 10, a slide member 1400 includes a first slide horizontal stop member 1410 and a second slide horizontal stop member 1460. The slide member 1400 includes slide side members 1430.

The first slide horizontal stop member 1410, a second slide horizontal stop member 1460, and slide side members 1430 form a volume or channel for encompassing the base member (not shown) when engaged therewith. The slide side members 1430 include slide opposing through holes 1450. The slide opposing through holes 1450 are opposing such that a through hole located on one slide side member has a corresponding opposing through hole on the other opposite slide side member. Adjacent slide opposing through holes 1450 have a first predetermined distance 1470 therebetween.

The first slide horizontal stop member 1410 is configured such that the ladder foot vertical stop member (not shown) is attached thereto. The second slide horizontal stop member 1490 is configured such that a ratchet 1460 of a ratcheted strap assembly (having strap 1480) is attached thereto.

The ratcheted strap of the slide member 1400 is configured to hold the foot of the ladder leg against the ladder foot vertical stop member (not shown).

The slide member 1400 can be utilized when a foot of a ladder leg is too big to fit in the volume created by the slide member 140 and optional cover member 1370.

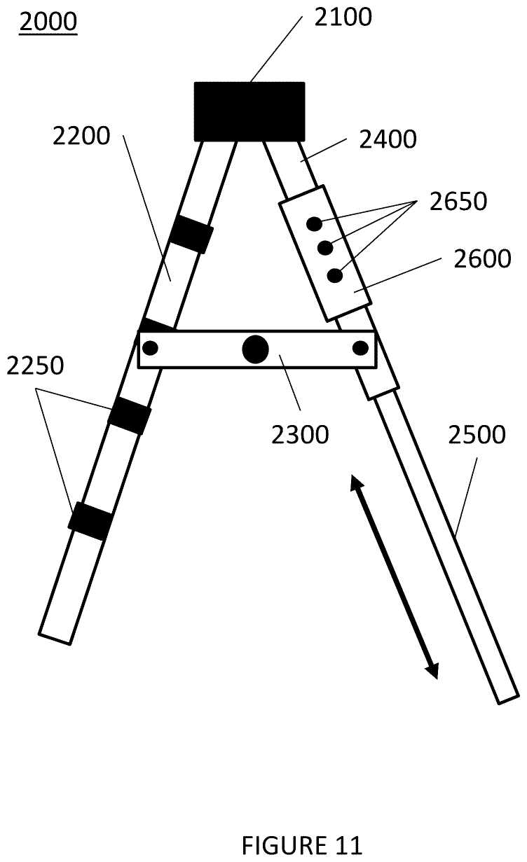

FIG. 11 illustrates and assembled adjustable level ladder. As illustrated in FIG. 11, an assembled adjustable level ladder 2000 includes a first set of legs 2200 that includes steps 2250. Each leg of the first set of legs 2200 is a first predetermined length and is rotatably attached to a top 2100.

The assembled adjustable level ladder 2000 includes a second set of legs 2400 that are rotatably attached to the top 2100. Each leg of the second set of legs 2400 is a second predetermined length. The second predetermined length is shorter than the first predetermined length.

The second set of legs 2400 are connected to the first set of legs 2200 via a pairs of foldable support arms 2300, configured to lock the first set of legs 2200 and the second set of legs 2400 into a usable state.

The assembled adjustable level ladder 2000 includes a third set of legs 2500. Each of the third set of legs 2500 is slidably engaged with a leg of the second set of legs 2400 via an interface member 2600. The interface member 2600 is configured as a channel, wherein a leg of the second set of legs 2400 slidably travels therein. The channel may substantially surround a leg of the second set of legs 2400.

The interface member 2600 includes a set of opposing through holes 2650. The opposing through holes 2650 are opposing such that a through hole located on one side of the interface member 2600 has a corresponding opposing through hole on the other opposite side of the interface member 2600. Adjacent opposing through holes 2650 have a third predetermined distance therebetween.

The third set of legs 2500 can move slidably along, as illustrated by the double arrowed line, the second set of legs 2400 to vary the total length of the second set of legs 2400 and the third set of legs 2500. The total length of the second set of legs 2400 and the third set of legs 2500 may be: (1) shorter than the first predetermined length of the first set of legs 2200; (2) longer than the first predetermined length of the first set of legs 2200; or (3) equal to the first predetermined length of the first set of legs 2200.

The length of total length of the second set of legs 2400 and the third set of legs 2500 may be locked into place by engaging a pin (not shown) with the opposing through holes 2650 of the interface member 2600 and opposing through holes (not shown) of the second set of legs 2400.

It is noted that the second set of legs 2400 may include stops (not shown) to limit the length of slidability of the interface member 2600 of the third set of legs 2500.

It is further noted that a non-skid member (not shown) may be located at ends of the third set of legs 2500 and/or the first set of legs 2200.

Additionally, it is noted that a pivotal foot (not shown) may be attached at ends of the third set of legs 2500 and/or the first set of legs 2200 to properly engage a surface while maintaining a desired slope of the adjustable level ladder.

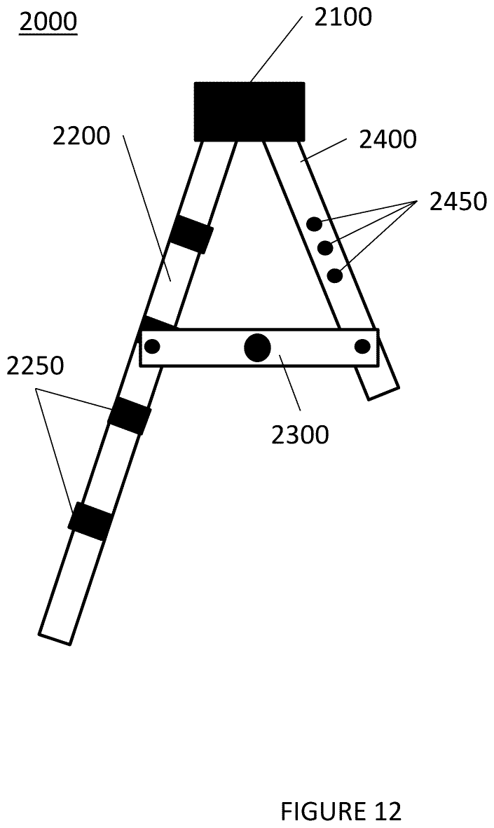

FIG. 12 shows the adjustable level ladder without the leveler member. As illustrated in FIG. 12, an assembled adjustable level ladder 2000 includes a first set of legs 2200 that includes steps 2250. Each leg of the first set of legs 2200 is a first predetermined length and is rotatably attached to a top 2100.

The assembled adjustable level ladder 2000 includes a second set of legs 2400 that are rotatably attached to the top 2100. Each leg of the second set of legs 2400 is a second predetermined length. The second predetermined length is shorter than the first predetermined length.

The second set of legs 2400 are connected to the first set of legs 2200 via a pairs of foldable support arms 2300, configured to lock the first set of legs 2200 and the second set of legs 2400 into a usable state.

Each leg of second set of legs 2400 includes a set of opposing through holes 2450. The opposing through holes 2450 are opposing such that a through hole located on one side of a leg of the second set of legs 2400 has a corresponding opposing through hole on the other leg of the second set of legs 2400. Adjacent opposing through holes 2450 have a fourth predetermined distance therebetween.

It is noted that the third predetermined distance between adjacent opposing through holes 2650 of the interface member 2600 is not equal to the fourth predetermined distance between adjacent opposing through holes 2450 of the second set of legs 2400. The configuration of the non-equal distances between adjacent through holes allows greater range for adjusting the adjustable ladder leveler to a desired length.

For example, the third predetermined distance between adjacent opposing through holes 2650 of the interface member 2600 may be one inch, whereas the fourth predetermined distance between adjacent opposing through holes 2450 of the second set of legs 2400 may be ⅞^{th} of an inch. The third predetermined distance between adjacent opposing through holes 2650 of the interface member 2600 may be greater than the fourth predetermined distance between adjacent opposing through holes 2450 of the second set of legs 2400. The third predetermined distance between adjacent opposing through holes 2650 of the interface member 2600 may be less than the fourth predetermined distance between adjacent opposing through holes 2450 of the second set of legs 2400.

The adjustable ladder leveler can be used to level an extension ladder on an uneven surface. The adjustable ladder leveler can also be used to extend the length of the extension ladder. The adjustable ladder leveler can be used to level a step ladder on a ramp or a step ladder on a set of stairs.

As discussed above, the first predetermined distance between the through holes of the slide member is not equal to the second predetermined distance between the through holes of the base member. The configuration of the non-equal distances between adjacent through holes allows greater range for adjusting the adjustable ladder leveler to a desired length.

An adjustable ladder leveler comprises a channel shaped base member; a slide member, slidably engaged with the channel shaped base member; a ladder foot holder member, operatively connected to the slide member, configured to engage a foot of a ladder; and a ladder leveler pivotal foot member, operatively connected to an end of the channel shaped base member, configured to engage a surface; the channel shaped base member including a set of channel shaped base member opposing through holes; the slide member including a set of slide member opposing through holes.

Adjacent opposing through holes of the set of channel shaped base member opposing through holes may have a first predetermined distance therebetween and adjacent opposing through holes of the set of slide member opposing through holes may have a second predetermined distance therebetween; the first predetermined distance being not equal to the second predetermined distance.

The first predetermined distance may be less than the second predetermined distance. The first predetermined distance may be greater than the second predetermined distance.

The adjustable ladder leveler may further comprise a non-skid member located at an end of the channel shaped base member opposite the ladder leveler pivotal foot member.

The channel shaped base member may include an attachment member configured to secure a leg of a ladder to the channel shaped base member.

The attachment member may be a strap. The attachment member may be a rachet strap.

The channel shaped base member may be U-shaped.

An adjustable ladder es a top member; a first set of legs, rotatably attached to the top member, the first set of legs including steps therebetween, each leg of the first step having a first predetermined length; a second set of legs rotatably attached to the top member, each leg of the second set of legs having a second predetermined length, the second predetermined length being shorter than the first predetermined length; and a third set of legs, each leg of the third set of legs being slidably engaged with a leg of the second set of legs; each leg of the third set of legs including an interface member configured to slidably engaged with a leg of the second set of legs; the interface member including a set of interface member opposing through holes; each leg of the second set of legs including a set of second set of legs opposing through holes.

Adjacent opposing through holes of the set of interface member opposing through holes may have a first predetermined distance therebetween and adjacent opposing through holes of the set of second set of legs opposing through holes may have a second predetermined distance therebetween, the first predetermined distance being not equal to the second predetermined distance.

The first predetermined distance may be less than the second predetermined distance. The first predetermined distance may be greater than the second predetermined distance.

It will be appreciated that variations of the above-disclosed embodiments and other features and functions, or alternatives thereof, may be desirably combined into many other different systems or applications.

Also, various presently unforeseen or unanticipated alternatives, modifications, variations, or improvements therein may be subsequently made by those skilled in the art which are also intended to be encompassed by the description above.

What is claimed is:

1. An adjustable ladder leveler comprising:
a channel shaped base member;
a slide member, slidably engaged with said channel shaped base member;
a ladder foot holder member, operatively connected to said slide member, configured to engage a foot of a ladder; and
a ladder leveler pivotal foot member, operatively connected to an end of said channel shaped base member, configured to engage a surface;
said channel shaped base member including a set of channel shaped base member opposing through holes;
said slide member including a set of slide member opposing through holes.

2. The adjustable ladder leveler as claimed in claim 1, wherein adjacent opposing through holes of said set of channel shaped base member opposing through holes have a first predetermined distance therebetween and adjacent opposing through holes of said set of slide member opposing through holes have a second predetermined distance therebetween;
said first predetermined distance being not equal to said second predetermined distance.

3. The adjustable ladder leveler as claimed in claim 2, wherein said first predetermined distance is less than said second predetermined distance.

4. The adjustable ladder leveler as claimed in claim 2, wherein said first predetermined distance is greater than said second predetermined distance.

5. The adjustable ladder leveler as claimed in claim 1, further comprising:
a non-skid member located at an end of said channel shaped base member opposite said ladder leveler pivotal foot member.

6. The adjustable ladder leveler as claimed in claim 1, wherein said channel shaped base member includes an attachment member configured to secure a leg of a ladder to said channel shaped base member.

7. The adjustable ladder leveler as claimed in claim 7, wherein said attachment member is a strap.

8. The adjustable ladder leveler as claimed in claim 7, wherein said attachment member is a rachet strap.

9. The adjustable ladder leveler as claimed in claim 1, wherein said channel shaped base member is U-shaped.

10. An adjustable ladder comprising:
a top member;
a first set of legs, rotatably attached to said top member, said first set of legs including steps therebetween, each leg of said first step having a first predetermined length;
a second set of legs rotatably attached to said top member, each leg of said second set of legs having a second predetermined length, said second predetermined length being shorter than said first predetermined length; and
a third set of legs, each leg of said third set of legs being slidably engaged with a leg of said second set of legs;
each leg of said third set of legs including an interface member configured to slidably engaged with a leg of said second set of legs;
said interface member including a set of interface member opposing through holes;
each leg of said second set of legs including a set of second set of legs opposing through holes.

11. The adjustable ladder as claimed in claim 10, wherein adjacent opposing through holes of said set of interface member opposing through holes have a first predetermined distance therebetween and adjacent opposing through holes of said set of second set of legs opposing through holes have a second predetermined distance therebetween;
said first predetermined distance being not equal to said second predetermined distance.

12. The adjustable ladder as claimed in claim 11 wherein said first predetermined distance is less than said second predetermined distance.

13. The adjustable ladder leveler as claimed in claim 11, wherein said first predetermined distance is greater than said second predetermined distance.
